(19) United States
(12) Patent Application Publication
(10) Pub. No.: US 2026/0083275 A1
(43) Pub. Date: Mar. 26, 2026

(54) BEVERAGE DISPENSER

(71) Applicant: SOCIÉTÉ DES PRODUITS NESTLÉ S.A., Vevey (CH)

(72) Inventors: Alexandre PUGLIESE, Paudex (CH); Nicolas OBLIGER, Franey (FR); Christian JARISCH, Lutry (CH); Bertrand GUYON, Lausanne (CH); Alexandre PERENTES, Sullens (CH)

(21) Appl. No.: 19/113,598

(22) PCT Filed: Sep. 20, 2023
(86) PCT No.: PCT/EP2023/075870

§ 371 Date: Mar. 20, 2025

(30) Foreign Application Priority Data
Sep. 22, 2022 (EP) 22197143.5

(51) Int. Cl. A47J 31/50; A47J 31/44; F25D 31/00

(52) U.S. Cl. CPC A47J 31/50; A47J 31/4403; F25D 31/002

(57) ABSTRACT

The invention concerns a beverage dispenser comprising: -a coffee machine to produce hot coffee and hot coffee combined with milk, said coffee machine comprising a milk tank, said milk tank being replenishable with cold milk,-a fridge comprising a cooling compartment and a freezer compartment, -a coffee cooler to cool hot coffee produced by the coffee machine, said coffee cooler comprising a vessel to hold coffee dispensed from the coffee machine and the wall of said vessel comprising a circulating path for a cooling fluid, wherein the freezer compartment of the fridge comprises a cooling fluid container for storing said cooling fluid, and wherein the beverage dispenser comprises an external cooling fluid circuit, said external cooling fluid circuit being configured to circulate the cooling fluid between said cooling fluid container and the circulating path of the coffee cooler.

### FIELD OF THE INVENTION

The present invention relates to the preparation of cold coffee and cold beverages.

### BACKGROUND OF THE INVENTION

Numerous solutions exist for preparing cold coffee from a hot extracted coffee. Most of the solutions propose to cool the hot coffee in its path from the coffee preparation unit to the dispensing area and the drinking cup. This dispensing path can be placed in contact with a heat exchanger supplied with a cooling fluid presenting a low temperature. If the temperature of the cooling fluid is not low enough, the exchange of heat does not enable an important decrease of the temperature of the hot coffee during its dispensing and the dispensed coffee cannot reach a temperature that can really be felt as cold. This is usually compensated by the addition of ice which dilutes the coffee.

With a very cold cooling fluid (presenting a temperature largely inferior to 0 ° C.), the heat exchange can be faster but this solution requires a coffee machine integrating a cold generation unit. Generally, a cold generation unit comprises a refrigeration circuit having a refrigerant circulating therein for generating cold and comprising a compressor, a condenser, an expansion means (expansion valve or capillarity tubes) and an evaporator for treating the refrigerant. These devices strongly increase the cost of the coffee machine and using a cold generation unit only for the heat exchanger of the hot coffee dispensing line is rarely implemented.

An object of the invention is to address the above existing problems.

### SUMMARY OF THE INVENTION

Objects of the invention are achieved by the beverage dispenser according to claims 1 to 8.

### BRIEF DESCRIPTION OF THE DRAWINGS

Specific embodiments of the invention are described further, by way of example, with reference to the following drawings in which:

FIG. 1 is a schematic view of a beverage dispenser according to the invention,

FIG. 2 is a schematic view of the coffee cooler,

FIGS. 3A, 3B are isolated view of a cooling fluid container 4,

FIG. 3C is a schematic view of the cooling fluid container 4, the internal cooling fluid circuit and the cold generation unit,

FIGS. 3D and 3E are section views according to plane AA and BB respectively of FIG. 3B.

FIG. 4 illustrates a different architecture of the beverage dispenser according to the invention.

### DETAILED DESCRIPTION OF EXEMPLARY EMBODIMENTS

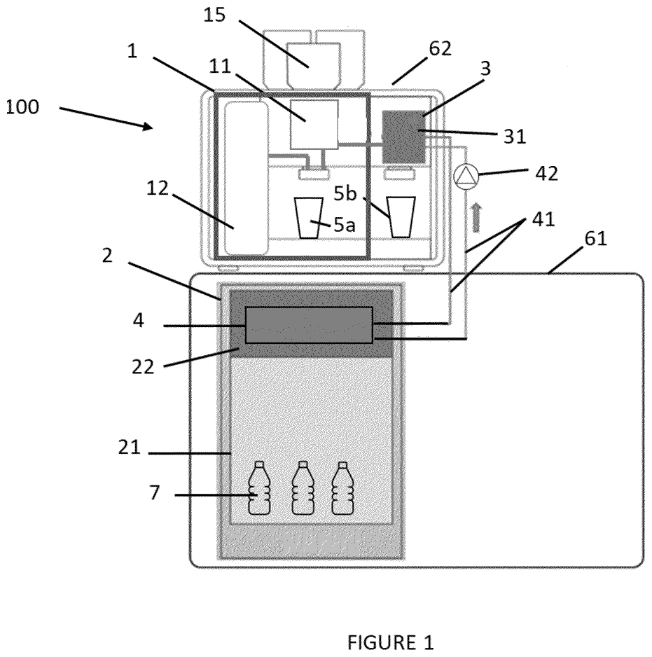

FIG. 1 illustrates a beverage dispenser 100 according to the invention. The dispenser is an assembly of different sub-units that are fluidically connected.

The first sub-unit is a coffee machine 1. This coffee machine is configured to produce hot coffee. preferably hot coffee is prepared by extraction of roast and ground coffee with hot water in a brewing unit 11, The machine can comprise a replenishable coffee beans container 15 and a grinder (not illustrated) to supply the brewing unit with a dose of roasted and ground coffee.

Alternatively, the coffee machine can prepare hot coffee from coffee capsules, the brewing unit being a capsule cage configured to open the capsule and extract coffee therefrom.

In a less preferred mode, coffee can be prepared from soluble coffee and the coffee machine comprises a mixing chamber to mix a dose of soluble coffee with hot water.

Prepared coffee is dispensed in a cup 5 at a dispensing area of the dispenser.

The coffee machine is configured to enable the addition of fresh milk to the prepared coffee. Accordingly, the coffee machine comprises a fresh milk tank 12 and means to dispense a dose of milk in the cup 5a at the dispensing area. This milk can be frothed during its dispensing. This milk tank is configured to store a certain amount of milk during the day and preferably for this reason is heat insulated. It is replenishable with cold fresh milk.

The second sub-unit of the beverage dispenser is a fridge 2. This fridge comprises a chilling compartment 21 that enables the storage of numerous fresh milk bottles. Accordingly, the milk tank 12 of the coffee machine can always be refilled with milk at the right cold temperature. The temperature of the chilling compartment is above 0° C., usually between 5 and 10° C.

In addition, the fridge comprises a freezing compartment 2 wherein the temperature is below 0° C., preferably below −15° C.

The third sub-unit of the beverage dispenser is a coffee cooler 3.

This device is configured to cool hot coffee produced by the coffee machine. Accordingly, the coffee machine comprises a coffee outlet to dispense hot prepared coffee from the brewing unit 11 to the coffee cooler in place of dispensing in the cup 5a positioned below the brewing unit. The coffee cooler comprises a vessel 31 to receive and hold hot coffee dispensed from the coffee machine. The wall 31 of the vessel comprises a circulating path 32 for a cooling fluid. Consequently, this cooling device enables the cooling of the hot coffee by heat exchange with the cooling fluid through contact along the wall of the vessel.

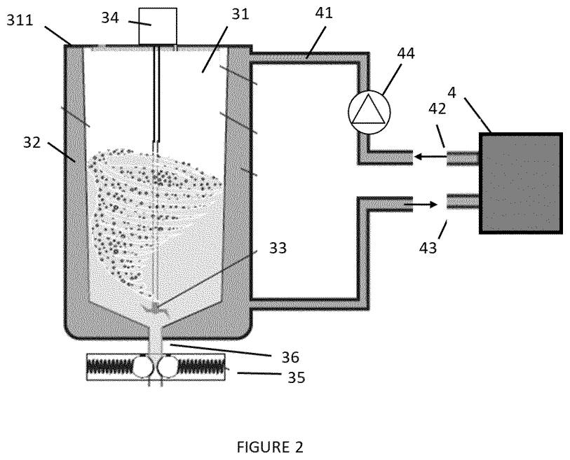

FIG. 2 illustrates one possible embodiment of the coffee cooler. The coffee cooler comprises a liquid mixing means, such as the illustrated whipper 33 actuated by a motor 34, to enable the circulation of coffee inside the vessel and improve the heat exchange along the wall 311 of the vessel.

A pinching valve 35 at the dispensing outlet 36 of the vessel enables a longer retention of the coffee inside the vessel until the desired cold temperature is reached.

The vessel presents a double wall configuration so that the cooling fluid is able to circulate inside the wall to exchange heat with the hot coffee agitated inside the vessel. The cooling fluid is provided through an external cooling fluid circuit 41 connected to a supply of cooling fluid. The supply of cooling fluid is a cooling fluid container 4 that is part of the circuit. Inside this circuit 41, the circulation is enabled by a pump 44. This cooling fluid container 4 provides an important volume of cooling fluid which enables the cooling of successive extracted coffee guaranteeing a high throughput for cold coffees.

In the beverage dispenser, the cooling fluid container 4 is positioned inside the freezer compartment 22 of the fridge. Accordingly, the cold generation unit of the fridge can be used simultaneously to chill the milk bottles and to cool down the cooling fluid of the coffee cooler. There is no need for an additional cold generation unit dedicated for the coffee cooler sub-unit. The use of the cold generation unit of the fridge is shared between the different devices of the beverage dispenser and the cost is optimised.

The container of cooling fluid provides an important quantity of cooling fluid at low temperature enabling the rapid cooling of a hot coffee or the successive cooling operations of several hot coffees or the cooling of several coffees simultaneously.

Preferably, the different sub-units 1, 2, 3 are enclosed in housings 61, 62.

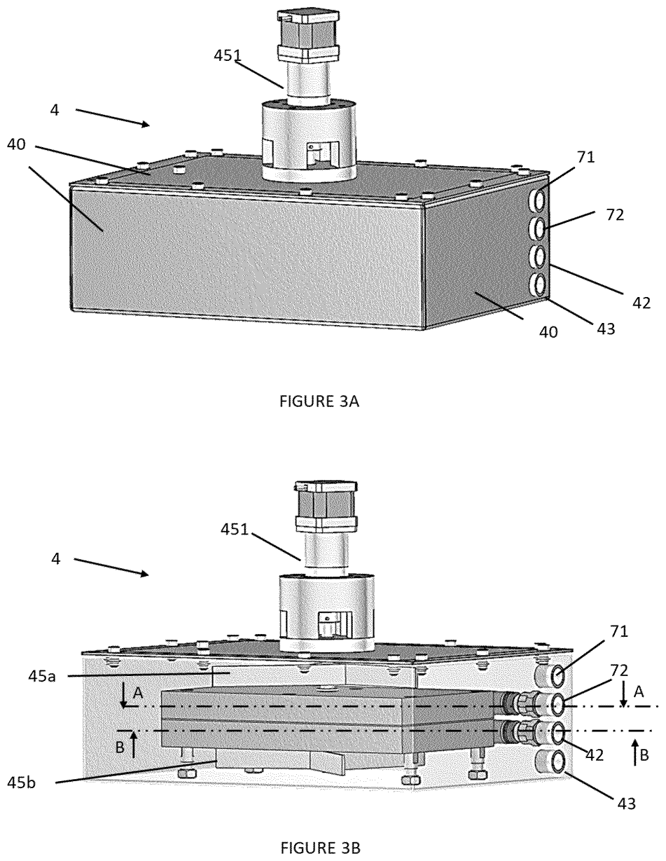

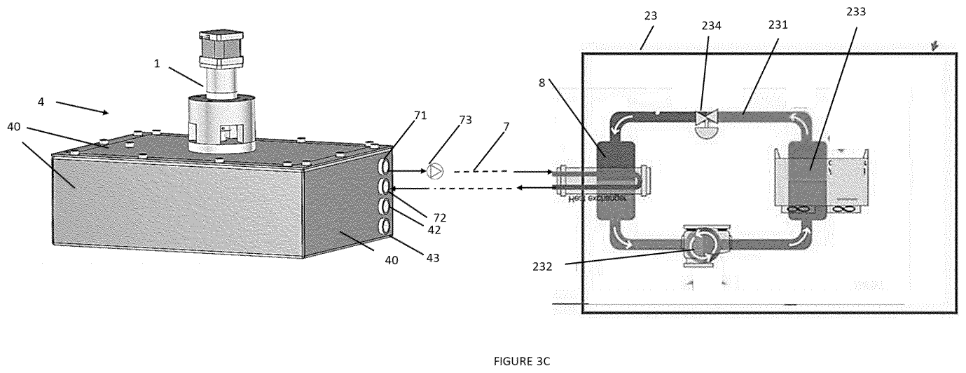

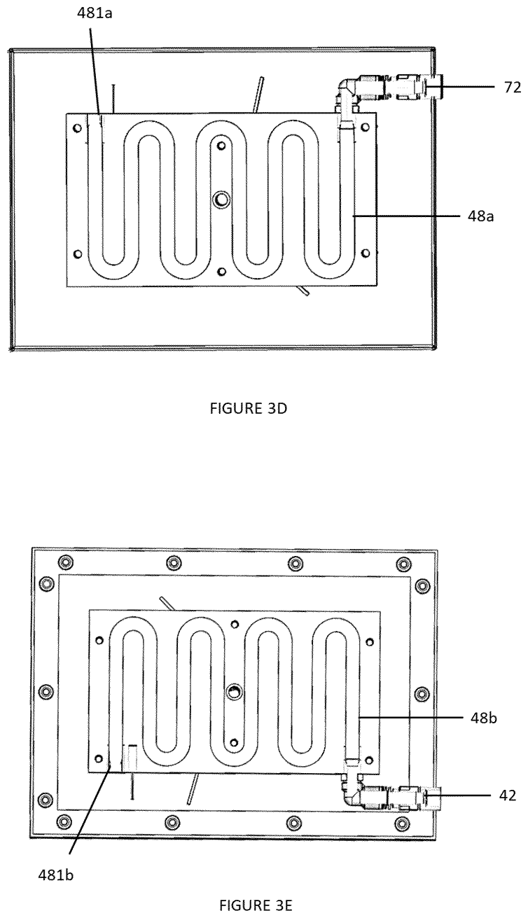

FIG. 3A is an isolated view of a particular embodiment of the cooling fluid container 4. The container comprises several walls 40 defining the internal volume of the container. Several inlets and outlets 42, 43, 72, 73 are provided in one wall or positioned in different walls depending on the design of the container and the architecture of the beverage dispenser. One wall is crossed by a rotating shaft 451. As illustrated in FIG. 3B, wherein the walls were made transparent, this shaft 451 cooperates with two agitators 45a, 45b designed to agitate the cooling fluid inside the container.

Two of the inlets and outlets are connected to the external cooling fluid circuit 41 of the coffee cooler. One is the fridge external outlet 42 that supplies the external cooling fluid circuit 41 and the coffee cooler 3 with the cooling fluid at low temperature and the other is the fridge external inlet 43 through which the heated cooling fluid flows back to the container 4.

As the container 4 is positioned in the freezing compartment, openings are provided in the housing of the fridge.

The two other inlets and outlets are connected to an internal cooling fluid circuit 7 schematically illustrated in FIG. 3C. This internal cooling fluid circuit is configured to circulate the cooling fluid between the cooling fluid container 4 and a heat exchanger 8, wherein the temperature of the cooling fluid is decreased. The cooling fluid is pumped by a pump 73 from the fridge internal outlet 71 to the heat exchanger 8 and then the colder fluid is circulated back to the container through the fridge internal inlet 72.

This heat exchanger 8 is configured to exchange heat between the cooling fluid and the refrigerant of the cold generation unit 23 of the fridge. In a well-known manner, the cold generation unit 23 of the fridge comprises a refrigeration circuit 231 having a refrigerant circulating therein and comprising at least:
a compressor 232,
a condenser 233,
an expansion means 234.

FIG. 3D is the section view of FIG. 3B according to plane AA. It makes apparent that the container 4 comprises a first internal channel 48a to control the path of the cold cooling fluid flowing back from the internal cooling fluid circuit 7 and entering at the fridge internal inlet 72. In a similar way, FIG. 3E is the section view of FIG. 3B according to plane BB. It makes apparent that the container 4 comprises a second internal channel 48b to control the path of the cooling fluid flowing to the external circuit 41 to the coffee cooler 3 and exiting at the fridge external outlet 42.

These two channels 48a, 48b are positioned one along the other inside the cooling container in order to optimise the heat exchange between these two fluids that present an important gradient of temperature.

The ends 481a, 481b of both channels emerge in the common free internal volume of the container, where the cooling fluid flowing from the different circuits is homogenised. The agitators participate to the homogenisation of the temperature of the cooling fluid inside the container.

Preferably, the cooling liquid is propylene glycol. Such a fluid can reach a temperature of −25° C. and rapidly cool the hot coffee through the wall of the coffee cooler.

As the viscosity of such a fluid can vary with temperature, it is preferable to use of a storing container that comprises agitators and internal channels to facilitate the homogenisation of its temperature.

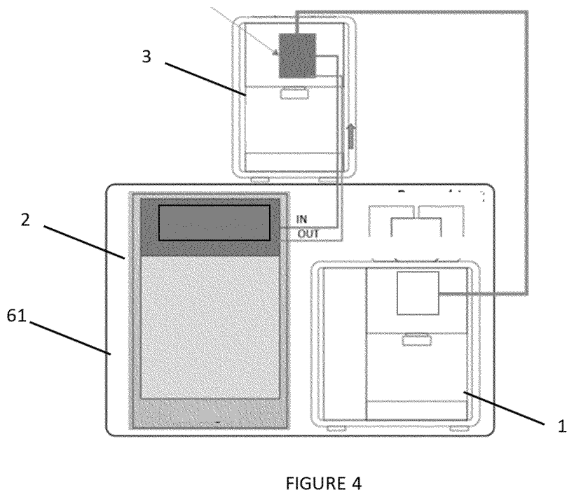

FIG. 4 illustrates a different architecture of the beverage dispenser according to the invention wherein the fridge and the coffee machine are positioned in the same housing and the coffee cooler is positioned above.

Although the invention has been described with reference to the above illustrated embodiments, it will be appreciated that the invention as claimed is not limited in any way by these illustrated embodiments.

Variations and modifications may be made without departing from the scope of the invention as defined in the claims. Furthermore, where known equivalents exist to specific features, such equivalents are incorporated as if specifically referred in this specification.

As used in this specification, the words “comprises”, “comprising”, and similar words, are not to be interpreted in an exclusive or exhaustive sense. In other words, they are intended to mean “including, but not limited to”.

### LIST OF REFERENCES IN THE DRAWINGS

beverage dispenser 100
coffee machine 1
coffee preparation unit 11
milk tank 12
dispensing outlet to cup 13a, 13b
connection to coffee cooler 14
coffee beans hopper 15
fridge 2
chilling compartment 21
freezer compartment 22
cold generation unit 23
refrigeration circuit 231
compressor 232
condenser 233
expansion means 234
coffee cooler 3
vessel 31
wall 311
circulating path 32
whipper 33
motor 34
pinching valve 35
dispensing outlet 36
cooling fluid container 4
external circuit 41
fridge external outlet 42
fridge external inlet 43
pump 44
agitator 45a, 45b
shaft 46
internal channel 48a, 48b
channel outlet 481a, 481b
cup 5a, 5b
housing 61, 62
internal cooling fluid circuit 7
fridge internal outlet 71
fridge internal inlet 72
pump 73
heat exchanger 8

1. A beverage dispenser comprising:
a coffee machine to produce hot coffee and hot coffee combined with milk, the coffee machine comprising a milk tank, the milk tank being replenishable with milk;
a fridge comprising:
a chilling compartment to store and chill milk containers at a temperature above 0° C., and
a freezer compartment able to hold temperature below 0° C.; and
a coffee cooler to cool the hot coffee produced by the coffee machine, the coffee cooler comprising a vessel to hold the coffee dispensed from the coffee machine, and a wall of the vessel comprising a circulating path for a cooling fluid,
wherein the freezer compartment of the fridge comprises a cooling fluid container for storing and cooling the cooling fluid, and
wherein the beverage dispenser comprises an external cooling fluid circuit, the external cooling fluid circuit configured to circulate the cooling fluid between the cooling fluid container and the circulating path of the coffee cooler.

2. The beverage according to claim 1, wherein the cooling fluid container for storing and cooling the cooling fluid comprises a fridge external inlet and a fridge external outlet for the cooling fluid, and the external cooling fluid circuit comprises a pump to circulate the cooling fluid from the fridge external said outlet to the circulating path of the coffee cooler and back to the fridge external inlet of the cooling fluid container.

3. The beverage dispenser according to claim 1, wherein the cooling liquid is propylene glycol.

4. The beverage dispenser according to claim 1, wherein the cooling fluid container for storing and cooling the cooling fluid comprises an agitator.

5. The beverage dispenser according to claim 1, wherein:
the fridge comprises at least one cold generation unit the at least one cold generation unit comprising a refrigeration circuit having a refrigerant circulating therein and comprising a compressor, a condenser, and an expansion member for treating the refrigerant, and
the beverage dispenser comprises an internal cooling fluid circuit, the internal cooling fluid circuit configured to circulate the cooling fluid between the cooling fluid container and a heat exchanger, the heat exchanger exchanging heat between the cooling fluid and the refrigerant of the at least one cold generation unit of the fridge.

6. The beverage dispenser according to claim 5, wherein the cooling fluid container for storing and cooling the cooling fluid comprises a fridge internal inlet and a fridge internal outlet for the cooling fluid, and the internal cooling fluid circuit comprises a pump to circulate the cooling fluid from the fridge internal outlet to the heat exchanger of the freezer and back to the fridge internal inlet of the cooling fluid container.

7. The beverage dispenser according to claim 1, wherein the cooling fluid container for storing and cooling the cooling fluid comprises internal channels, the internal channels configured to control circulation of different flows of the cooling fluid entering and/or exiting the cooling fluid container.

8. The beverage dispenser according to claim 5, wherein the cooling fluid container for storing and cooling the cooling fluid comprises an internal heat exchanger configured to exchange heat between the cooling fluid entering the cooling fluid container from the internal cooling fluid circuit and the cooling fluid exiting the container to the external cooling fluid circuit.

9. The beverage dispenser according to claim 1, wherein the milk tank is replenishable with cold milk.

10. The beverage dispenser according to claim 1, wherein the chilling compartment is configured to store and chill the milk containers at a temperature between 5 and 10° C.

11. The beverage dispenser according to claim 1, wherein the freezer compartment is configured to hold temperature below −15° C.
